(19) United States
(12) Patent Application Publication
(10) Pub. No.: US 2019/0047222 A1
(43) Pub. Date: Feb. 14, 2019

(54) TECHNIQUES FOR PRODUCING THERMAL SUPPORT STRUCTURES IN ADDITIVE FABRICATION AND RELATED SYSTEMS AND METHODS

(71) Applicant: Formlabs, Inc., Somerville, MA (US)

(72) Inventors: Eduardo Torrealba, Cambridge, MA (US); Steven Thomas, Cambridge, MA (US); Christopher Auld, Boston, MA (US); Justin Keenan, Lexington, MA (US)

(73) Assignee: Formlabs, Inc., Somerville, MA (US)

(21) Appl. No.: 16/102,912

(22) Filed: Aug. 14, 2018

Related U.S. Application Data
(60) Provisional application No. 62/545,231, filed on Aug. 14, 2017.

(51) Int. Cl. B29C 64/245; B29C 64/295; B29C 64/153; B29C 64/218; B29C 64/393

(52) U.S. Cl. CPC B29C 64/245; B29C 64/295; B33Y 10/00; B29C 64/218; B29C 64/393; B29C 64/153

(57) ABSTRACT

Techniques for designing and fabricating thermal supports via additive fabrication are described. In some additive fabrication techniques, sufficiently high temperature differentials may contribute to any of a diverse array of part defects and failure modes. Additional volumes, referred to as thermal supports, may be fabricated along with a desired object such that the thermal supports adjusted, in a desired manner, temperatures that would otherwise be experience within the fabrication material during fabrication. For instance, the presence of a thermal support structure may serve to reduce changes in temperature experienced by the material between one or more adjacent layers during fabrication. According to some embodiments, thermal supports may be generated to be fabricated with a part so as to not be in contact with the part. Such a thermal support may reduce a temperature differential without affecting the finish of the fabricated object.

### CROSS-REFERENCE TO RELATED APPLICATIONS

The present application claims the benefit under 35 U.S.C. § 119(e) of U.S. Provisional Patent Application No. 62/545,231, filed Aug. 14, 2017, titled “Techniques For Producing Thermal Support Structures In Additive Fabrication And Related Systems And Methods,” which is hereby incorporated by reference in its entirety.

### BACKGROUND

Additive fabrication, e.g., 3-dimensional (3D) printing, provides techniques for fabricating objects, typically by causing portions of a building material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, selective laser sintering or combinations thereof. Many additive fabrication techniques build parts by forming successive layers, which are typically cross-sections of the desired object. Typically each layer is formed such that it adheres to either a previously formed layer or a substrate upon which the object is built.

In one approach to additive fabrication, known as selective laser sintering, or “SLS,” solid objects are created by successively forming thin layers by selectively fusing together powdered material. One illustrative description of selective laser sintering may be found in U.S. Pat. No. 4,863,538, incorporated herein in its entirety by reference.

### SUMMARY OF THE DISCLOSURE

According to some aspects, a method of generating one or more thermal supports for an object is provided, the one or more thermal supports and the object to both be fabricated via an additive fabrication device, the method comprising identifying, based on a three-dimensional model of the object, at least a first region of the object to which thermal support is to be provided, generating at least a first thermal support structure for the first region of the object, the first thermal support structure being positioned under the first region, not in mechanical contact with the first region, and having a tapered shape wherein the first thermal support structure has a cross-sectional area proximate to the first region that is larger than a cross-sectional area of the first thermal support structure distal to the first region, and generating, using at least one processor, instructions that, when executed by the additive fabrication device, cause the additive fabrication device to fabricate the object and the first thermal support structure.

According to some aspects, at least one computer readable medium is provided comprising processor-executable instructions that, when executed, cause at least one processor to perform a method of generating one or more thermal supports for an object, the one or more thermal supports and the object to be fabricated via an additive fabrication device, the method comprising identifying, based on a three-dimensional model of the object, at least a first region of the object to which thermal support is to be provided, generating, using the at least one processor, at least a first thermal support structure for the first region of the object, the first thermal support structure being positioned under the first region, whilst not in mechanical contact with the first region, and having a tapered shape wherein the first thermal support structure has a cross-sectional area proximate to the first region that is larger than a cross-sectional area of the first thermal support structure distal to the first region, and generating, using the at least one processor, fabrication instructions that, when executed by the additive fabrication device, cause the additive fabrication device to fabricate the object and the first thermal support structure.

According to some aspects, a method of generating one or more supports for an object is provided, the one or more supports and the object to both be fabricated via an additive fabrication device from at least one material, the method comprising identifying, based on a three-dimensional model of the object, at least a first region of the object to which support is to be provided, generating at least a first structure for the first region of the object based at least in part on at least one measure of temperature expected within the at least one material during fabrication of the object, the first structure being positioned under the first region, not in mechanical contact with the first region, and having a tapered shape wherein the first structure has a cross-sectional area proximate to the first region that is larger than a cross-sectional area of the first structure distal to the first region, and generating, using at least one processor, instructions that, when executed by the additive fabrication device, cause the additive fabrication device to fabricate the object and the first structure.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF THE DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 depicts an illustrative selective laser sintering device, according to some embodiments;

FIG. 2 depicts a cross section of a fabricated object having an overhang, according to some embodiments;

FIGS. 3A-D depicts a cross section of a fabricated object and examples of different fabricated thermal support structures for the object, according to some embodiments;

FIG. 4 is a block diagram of a system suitable for practicing aspects of the invention, according to some embodiments; and

FIG. 5 illustrates an example of a computing system environment on which aspects of the invention may be implemented.

### DETAILED DESCRIPTION

Some additive fabrication techniques, such as Selective Laser Sintering (SLS), form objects by fusing fine material, such as one or more powders, together into larger solid masses. This process of fusing fine material together is referred to herein as “consolidation,” and typically occurs by directing sufficient energy (e.g., heat and/or light) to the material to cause consolidation. Some energy sources, such as lasers, allow for direct targeting of energy into a small area or volume. Other energy sources, such as heat beds or heat lamps, direct energy into a comparatively broader area or volume of material. Since consolidation of source material typically occurs at or above a critical temperature, producing parts as intended requires effective management of temperature within the source material.

In some such additive fabrication systems, the source material is preheated to a temperature that is sufficiently low as to require minimal additional energy exposure to trigger consolidation. For instance, some conventional system utilize radiating heating elements that aim to consistently and uniformly heat both the uppermost layer and the volume of the material to below, but close to, the critical temperature for consolidation. A laser beam or other energy source directed at the material may provide sufficient energy to cause consolidation, thereby allowing controlled consolidation of material at a small scale.

In these systems, consistency of the temperature of the unconsolidated material may be critical to the successful fabrication of parts using the selective sintering process, both over the full area to be exposed by the focused energy source and over an extended time period as additional exposures are completed. In particular, when consolidating the material, the system should preferably maintain the temperature of the material at or above its consolidation temperature for sufficient time for the consolidation process to complete. Additionally, the system should preferably maintain the temperature of the unconsolidated material at as close to a constant temperature as feasible so that the total amount of energy actually delivered to an area of unconsolidated material can be predicted for a given energy exposure amount.

The thermal management approaches described above can be difficult to implement in practice, however, and numerous problems can emerge as a result of inconsistent heating. For instance, overheating of material during fabrication may cause powdered material to clump or aggregated in unintended areas, which can prevent an even deposition of fresh material across the fabrication bed. Conversely, underheating of the material during fabrication may result in a failure of the material to consolidate and/or may result in inferior material properties within the fabricated part.

Dimensional changes in the consolidated material, also known as shrinkage, can also be significantly influenced by both the temperature of a particular portion of material prior to exposure to focused energy and to the temperature profile of that portion following the exposure. As an example, heating different regions of powder to different temperatures and/or allowing similarly heated regions to cool at different rates, may result in significantly different degrees of expansion and contraction due to the thermal energy and subsequent melting and consolidation. These differential expansions and contractions may cause numerous part defects, including cracking, incomplete consolidation, and warping. Inconsistent temperature at layers near to the surface of the powder bed, or at the powder bed surface, may be particularly troublesome, causing newly formed layers to warp and curl up. In some circumstances, such temperature differentials may prevent the formation of additional layers and may result in part failure. Referred to herein as “thermal shock,” these effects may be most pronounced when relatively cool regions are in immediate proximity to relatively hot regions of the powder bed, thus forming an undesirable temperature gradient between the cooler and warmer regions.

Some thermal management challenges are a result of significant heat applied to portions of material via exposure to a focused energy source. While this heat can cause consolidation, it also heats adjacent areas which may introduce additional temperature non-uniformities. The application and nature of these non-uniform “hot spots” can depend greatly upon the geometry of the part to be fabricated, and thus the areas exposed and heated by the focused energy source. This introduction of additional heat may tend to set up temperature differentials, or gradients, between layers and areas which have been recently exposed as compared to those layers and/or areas which have not been recently exposed. As discussed above, one undesirable result to such a temperature differential may be so-called thermal shock; when a fresh layer of comparatively cooler material is deposited over a layer into which a large amount of heat was deposited, consolidation in the new layer may result in warping or curling material as a result of this temperature differential. In general, sintering processes are known in the art to be sensitive to temperature differentials, resulting or believed to contribute to a diverse array of part defects and failure modes. Such differentials may be especially severe where the size of the area to be exposed by the focused energy changes significantly between layers—that is, when there is a large differential in the cross-sectional area being consolidated between adjacent and/or nearby layers.

Conventionally, an operator of a device might manually analyze a part for fabrication to identify regions likely to result in steep interlayer temperature gradients and, where feasible, to alter the orientation of the part with respect to the layer forming direction so as to minimize the rate at which cross sectional areas change between layers. While altering the orientation of the object may improve outcomes for a variety of shapes, however, there are some shapes that may not have such an optimal orientation.

The inventors have recognized and appreciated that temperature differentials between adjacent and/or nearby layers may be reduced by modification of the geometry of the part to be fabricated. In particular, the part may be modified to include additional volumes, referred to herein as thermal supports, which can be configured to reduce the overall rate of change of cross-sectional area from layer to layer, thereby reducing thermal gradients established by the selective application of thermal energy for material consolidation. For instance, slices through an inverted pyramid shape exhibit a gradually increasing cross-sectional area. By fabricating such a shape along with a desired part in a suitable position, the overall rate of change of the cross-sectional area to be consolidated from layer to layer may be reduced as compared with fabrication of the part alone.

As used herein, a “thermal support” or a “thermal support structure” refers at least to any structure fabricated in addition to a desired part that has a size and/or shape selected for the purpose of adjusting, in a desired manner, temperatures that would otherwise be experienced within the fabrication material during fabrication. In particular, the presence of the thermal support structure serves to reduce changes in temperature experienced by the material between one or more adjacent layers. While a structure generated to be fabricated in addition to a desired part may not in general be limited to any particular structure, in practice the shapes and/or sizes of structures that beneficially adjust the temperature profiles of the material during fabrication in this manner are limited to a subset of all possible such structures. Particular structures, like hemispheres or pyramids, have been found to be particularly effective at reducing layer-to-layer changes in temperature, as described below.

According to some embodiments, thermal supports may be generated to be fabricated with a part so as to not be in contact with the part. While proximity to the part may be desirable to reduce the differential heat load between layers of material, a thermal support positioned separate (e.g., one layer of material away) from the part may reduce a heat differential without affecting the finish of the fabricated part. Such thermal supports may be readily retrieved and discarded subsequent to fabrication. Alternatively, thermal supports may be generated in contact with the part and mechanically separated after fabrication has completed.

According to some embodiments, thermal supports may be generated to be positioned beneath regions of a part identified as overhanging. Typically, rapid changes in cross-sectional area of a part occur when the geometry of a part overhangs the region below. As such, generation of thermal supports may be based on identifying one or more of these overhanging regions and generating a suitable thermal support structure to be positioned beneath the overhang. As discussed above, such a support may be positioned in contact with, or not in contact with, the overhanging region.

According to some embodiments, thermal supports may be generated by considering an amount of thermal energy expected to be deposited into a number of layers of the fabricated part. Such a consideration may take into account the heat capacity of the material, the energy output of the focused energy source, the area on which said energy is focused, and/or other considerations. For instance, generating a thermal support may comprise determining an amount of desired heat reduction and optimizing a position and/or size and shape of a thermal support to be fabricated to provide said heat reduction by considering one or more of the above factors (and/or other factors).

According to some embodiments, thermal supports may be generated by optimizing parameters of a thermal support whilst minimizing the temperature gradient expected to be produced during fabrication. For instance, a thermal support having a pyramid shape may have dimensions describable by two or three parameters in addition to a position relative to a part described by one, two, three or more parameters. A preferred thermal support may thereby be generated by optimizing these parameters whilst minimizing one or more temperature gradients expected to be created during fabrication.

Following below are more detailed descriptions of various concepts related to, and embodiments of, techniques for producing thermal support structures. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

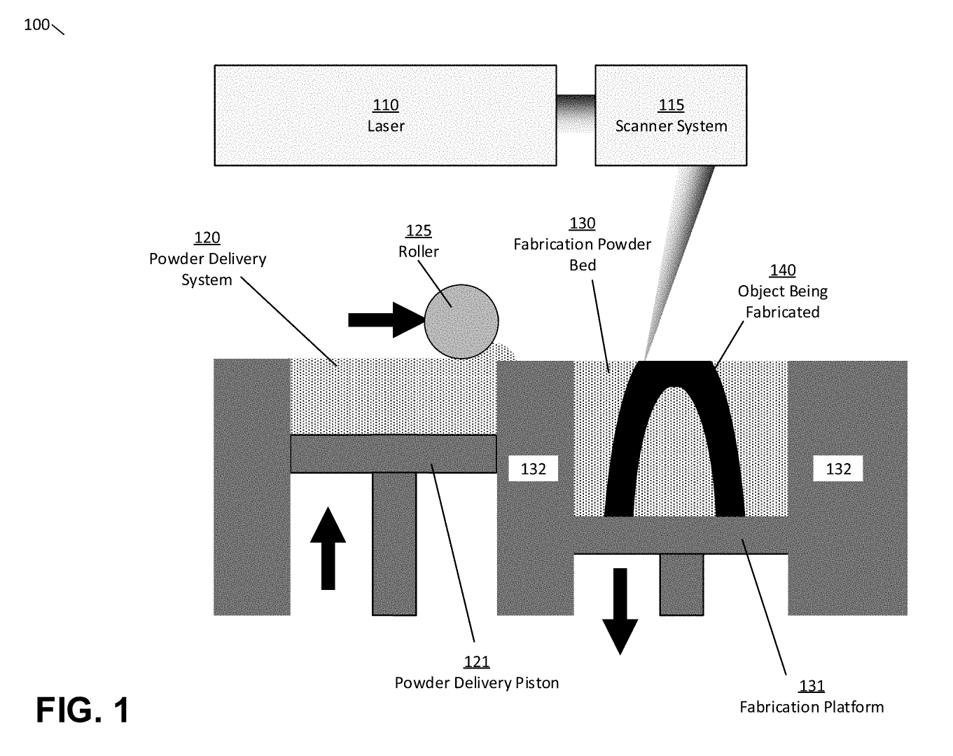

An illustrative system embodying certain aspects of the present application is depicted in FIG. 1. An illustrative selective laser sintering (SLS) additive fabrication device 100 comprises a laser 110 paired with a computer-controlled scanner system 115 disposed to operatively aim the laser 110 at the fabrication bed 130 and move over the area corresponding to a given cross-sectional area of a computer aided design (CAD) model representing a desired part. Suitable scanning systems may include one or more mechanical gantries, linear scanning devices using polygonal mirrors, and/or galvanometer-based scanning devices.

In the example of FIG. 1, the material in the fabrication bed 130 is selectively heated by the laser in a manner that causes the powder material particles to fuse (sometimes also referred to as “sintering” or “consolidating”) such that a new layer of the object 140 is formed. According to some embodiments, suitable powdered materials may include any of various forms of powdered nylon. Once a layer has been successfully formed, the fabrication platform 131 may be lowered a predetermined distance by a motion system (not pictured in FIG. 1). Once the fabrication platform 131 has been lowered, the material deposition mechanism 125 may be moved across a powder delivery system 120 and onto the fabrication bed 130, spreading a fresh layer of material across the fabrication bed 130 to be consolidated as described above. Mechanisms configured to apply a consistent layer of material onto the fabrication bed may include the use of wipers, rollers, blades, and/or other levelling mechanisms for moving material from a source of fresh material to a target location. Additional powder may be supplied from the powder delivery system 120 by moving the powder delivery piston 121 upwards.

Since material in the powder bed 130 is typically only consolidated in certain locations by the laser, some material will generally remain within the bed in an unconsolidated state. This unconsolidated material is commonly known in the art as the part cake. In some embodiments, the part cake may be used to physically support features such as overhangs and thin walls during the formation process, allowing for SLS systems to avoid the use of temporary mechanical support structures, such as may be used in other additive manufacturing techniques such as stereolithography. In addition, this may further allow parts with more complicated geometries, such as moveable joints or other isolated features, to be printed with interlocking but unconnected components.

The above-described process of producing a fresh layer of powder and consolidating material using the laser repeats to form an object layer-by-layer until the entire object has been fabricated. Once the object has been fully formed, the object and the part cake may be cooled at a controlled rate so as to limit issues that may arise with fast cooling, such as warping or other distortion due to variable rate cooling. The object and part cake may be cooled while within the selective laser sintering apparatus, or removed from the apparatus after fabrication to continue cooling. Once fully cooled, the object can be separated from the part cake by a variety of methods. The unused material in the part cake may optionally be recycled for use in subsequent prints.

In the example of FIG. 1, powder in the uppermost layer of the powder bed 130 is maintained at an elevated temperature, low enough to minimize thermal degradation, but high enough to require minimal additional energy exposure to trigger consolidation. Energy from the laser 110 is then applied to selected areas to cause consolidation. As discussed above, however, numerous problems can occur due to temperature differentials produced during this process. While some objects can be oriented so as to reduce or eliminate these issues, for most objects this is not feasible.

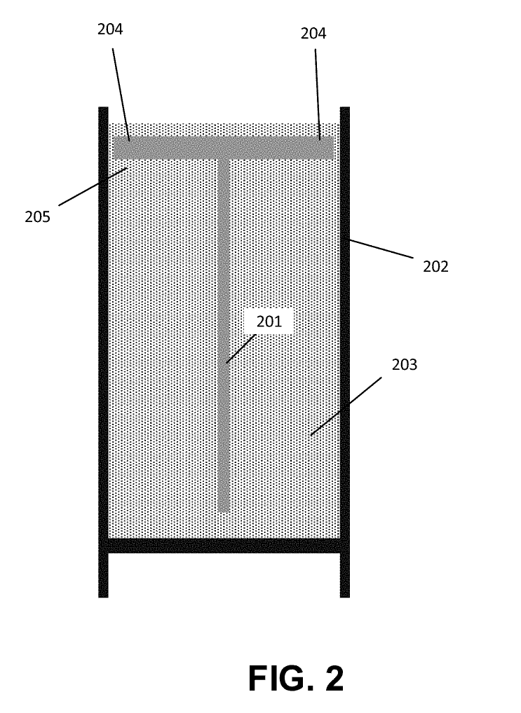

An illustrative object posing such a challenge is depicted in FIG. 2. As shown, a part 201 is formed within a build chamber 202 containing a powder material 203, which is consolidated to form object 201 and left in an unconsolidated state surrounding the part 201. For instance, the build chamber 202 may be the build chamber produced by the fabrication platform 131 and walls 132 as shown in FIG. 1. The illustrative part 201 includes areas of rapid change in cross-sectional area 204 which may be referred to as overhangs. If a focused energy source, such as a laser, is scanned along the first layer of the overhang 204, it generates a large area of heated and consolidating material, significantly hotter than material in the unexposed powder 205 below. Such an area 204 with minimal heating from the layers below may be significantly more likely to curl or distort during the fabrication process, with such distortion interfering with the printing process of subsequent layers as discussed previously.

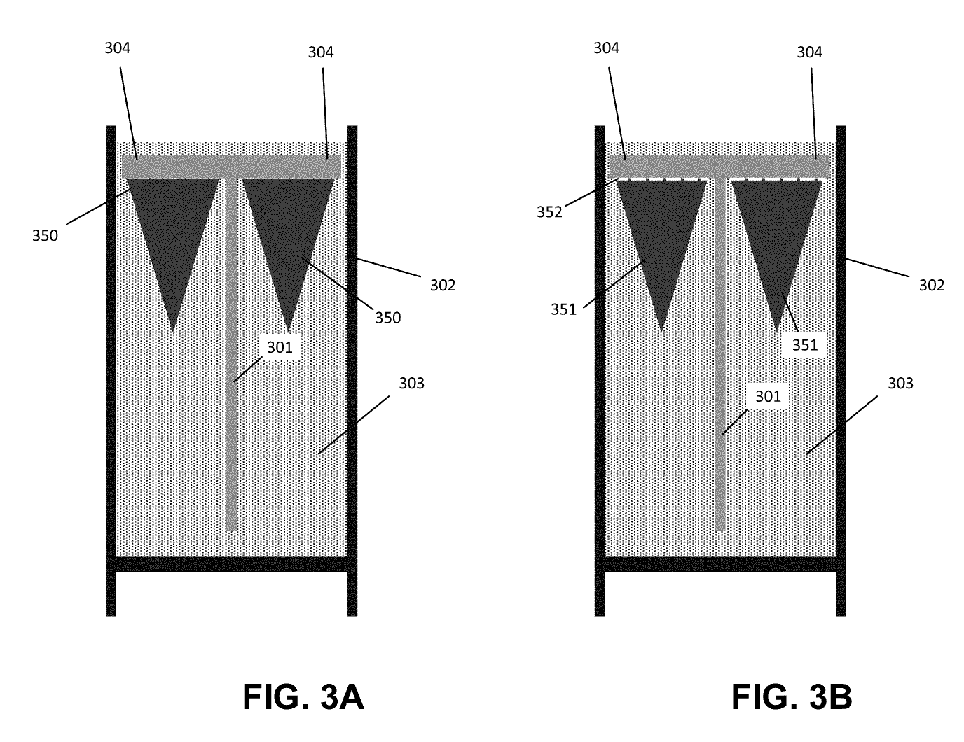

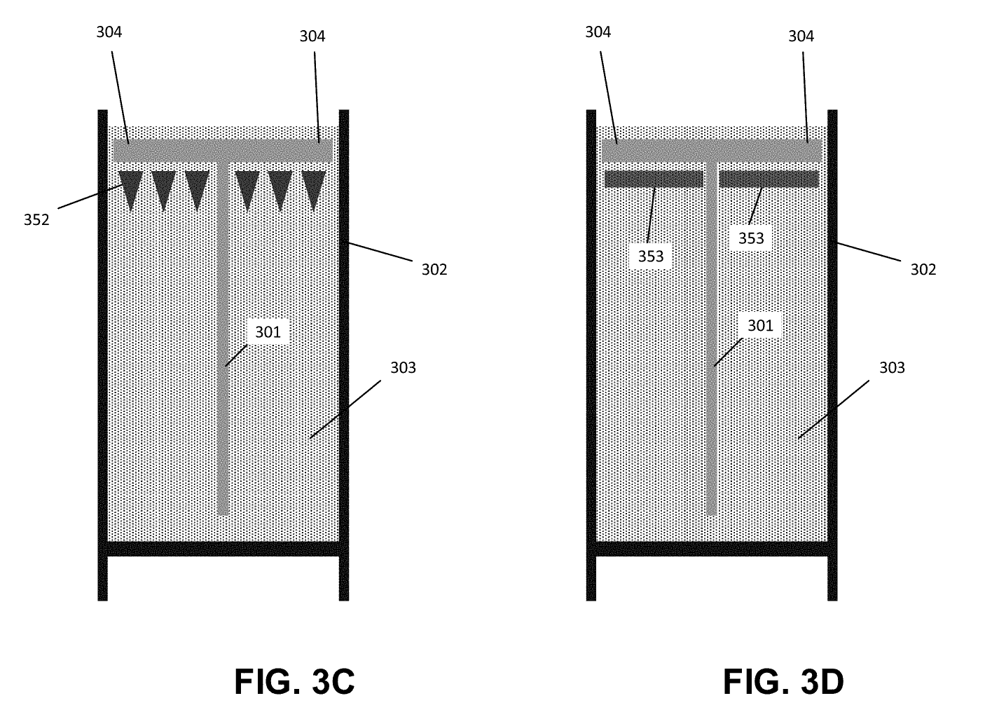

As discussed above and as shown in the examples of FIGS. 3A and 3B, the inventors have appreciated that these issues might be addressed by fabrication of thermal support structures. In the example of FIG. 3A, thermal supports 350 are included so as to minimize the rate of change of cross-sectional area during fabrication of the part 301 and thermal supports. As a result, any thermal gradient established by the selective application of thermal energy for layer consolidation is reduced.

As shown in FIGS. 3A-3D, a part 301 is formed within a build chamber 302 containing a powder material 303, which is consolidated to form object 301 and left in an unconsolidated state surrounding the part 301. For instance, the build chamber 302 may be the build chamber produced by the fabrication platform 131 and walls 132 as shown in FIG. 1.

As shown in profile in FIG. 3A, the geometry of illustrative thermal supports 350 has been selected to provide for a consistent rate of change of cross-sectional area. The illustrative thermal supports 350, shown in cross section in FIG. 3A, may be shaped as, for example, a cone, a triangular pyramid, or a cubic pyramid. In this example, the thermal support portions 350 of the part 301 may be formed from consolidated powder as part of and in the same manner as the other portions of the part 301 being formed. Such thermal supports 350 may then be removed from the part 301 following the formation process, leaving the desired part.

In some embodiments, the geometry of such thermal supports may be selected so as to increase the ratio of thermal support volume to thermal support surface area, and thus reduce the extent to which thermal energy within the thermal support equilibrates with the surrounding material. As one example, hemispherical shapes may be substituted for cone or similar shapes described above, thus providing maximal surface area at the interface, while maximizing volume to surface area elsewhere.

While thermal supports 350 shown in FIG. 3A may address some of the problems with temperature differentials described above, some issues may remain. As one example, the removal of thermal supports 350 attached to the part 301 may be undesirable for a variety of reasons, including the increased amount of post-processing required. As another example, the formation of such thermal supports may require a significant amount of material waste and increase in fabrication time due to additional exposed areas. These issues, and others, are addressed in further embodiments of the present invention described below.

In particular, the inventors have appreciated that thermal supports 350 do not need to be in mechanical contact with the part 301 being formed. In particular, some embodiments of the present invention may form thermal supports as described above, while leaving one or more layers of powder deposited onto the thermal supports and left unconsolidated. This result in shown in FIG. 3B, in which one or more layers of powder 352 are left between the thermal supports 351 and the region 304 of the part 301. Additional powder may then be dispensed and part layers consolidated above the thermal support and unconsolidated powder interface. By maintaining a sufficiently thin interface of unconsolidated material, such as a single 100 micron layer of recoated powder, sufficient heat to mitigate issues caused by a thermal gradient may flow between the thermal support 351 and the supported areas 304 of the part 301. As the interface 352 is unconsolidated, however, no mechanical connection between the thermal supports 351 and part 301 is typically formed, allowing for the easy removal of the completed part 301 without necessarily requiring any additional post-processing to separate the thermal supports 351.

In some embodiments, however, some degree of mechanical connection may be desired in order to facilitate the removal of thermal supports 351 from the powder bed 303 along with the part 301. Alternatively, the degree of thermal transfer through unconsolidated material 352 may be found to be inadequate. In such cases, a hybrid approach may be adopted, with portions of the interface area 352 consolidated, while other portions are left unconsolidated. Various patterns may be chosen for such an approach, including regularly spaced columns of consolidated material, linear extents of consolidated material, or other forms. In some embodiments, another such hybrid approach may be taken, wherein thermal supporting areas are exposed to sufficient energy to induce a predetermined degree-particle-melt (DPM), increasing localized thermal energy, while allowing for potential material reuse.

FIG. 3C provides a further illustrative example of an improved embodiment of the present invention wherein multiple, distinct thermal support components 352, rather than a single thermal support unit 351, may be generated to provide thermal management. As shown, the monolithic thermal supports shown in FIG. 3A or FIG. 3B may be instead each be substituted for two or more smaller thermal support components 352. Such thermal support components 352 may be distributed across an area 304 requiring thermal support in order to provide, in conjunction, sufficient thermal mass to avoid the gradient-related defects described above. Due to the smaller individual areas to be covered, such components 352 may be advantageously reduced both in individual volume and dimensions, while preserving the gradual increase in cross-sectional area provided by monolithic thermal supports. The total aggregate volume, moreover, of the thermal support components 352 may be reduced from the total volume of the monolithic thermal supports 351. This reduction of volume, in turn, may require less material and less processing time, while continuing to provide sufficient thermal support for the part being formed.

In some embodiments, not shown, connecting features may be fabricated that connect one or more thermal support components 352 to one another. Such connecting features may be provided in order to assist with the removal of thermal support components 352 from the unconsolidated powder 303, particularly in embodiments where thermal support components 352 may be comparatively much smaller than the part 304 or otherwise more difficult to extract individually. In some embodiments, thermal support components 352 may include connecting portions extending from thermal support regions towards one or more sources of thermal energy. In some instances, such thermal sources may be provided via heating elements located at predetermined points on a building surface, such that connecting portions may extend upwards from the building surface during the fabrication process and conduct thermal energy from the heating elements to one or more thermal support portions.

While the illustrative embodiments described above have described the consolidation of powder material 303 to form solidified thermal supports 350, 351 and 352, in some embodiments the net effect of forming such thermal supports may be achieved without causing consolidation of the material. That is, energy may be directed to material that is insufficient to cause consolidation yet sufficient to produce desired effects in reducing thermal gradients. Such an approach may improve speed and/or increase the amount of material that can be reused after fabrication.

As an illustrative example, FIG. 3D illustrates a result of applying a source of selective energy, such as a laser, at a power sufficient to raise the temperature of a region 353 of the unconsolidated powder 303, while providing insufficient energy to cause consolidation of the region 353. In some embodiments, the source of selective energy may be distinct from the source used to cause consolidation, while in other embodiments the same source may be used at a reduced power, duty cycle, focus, or other means of attenuation. As shown in FIG. 3D, one potential advantage of such an approach is to allow for flatter geometry for the unconsolidated thermal support 353, as the rapid cross sectional area change may be less significant within unconsolidated powder forming the support 353. Further, by avoiding consolidation, additional material may not be required or wasted in the formation of the thermal support 353 and may instead be reused. In some embodiments, any thermal degradation of the unconsolidated material used in the thermal supports may be reduced by the selective introduction of an inhibitory material to the regions used for the thermal supports during the deposition and/or exposure steps.

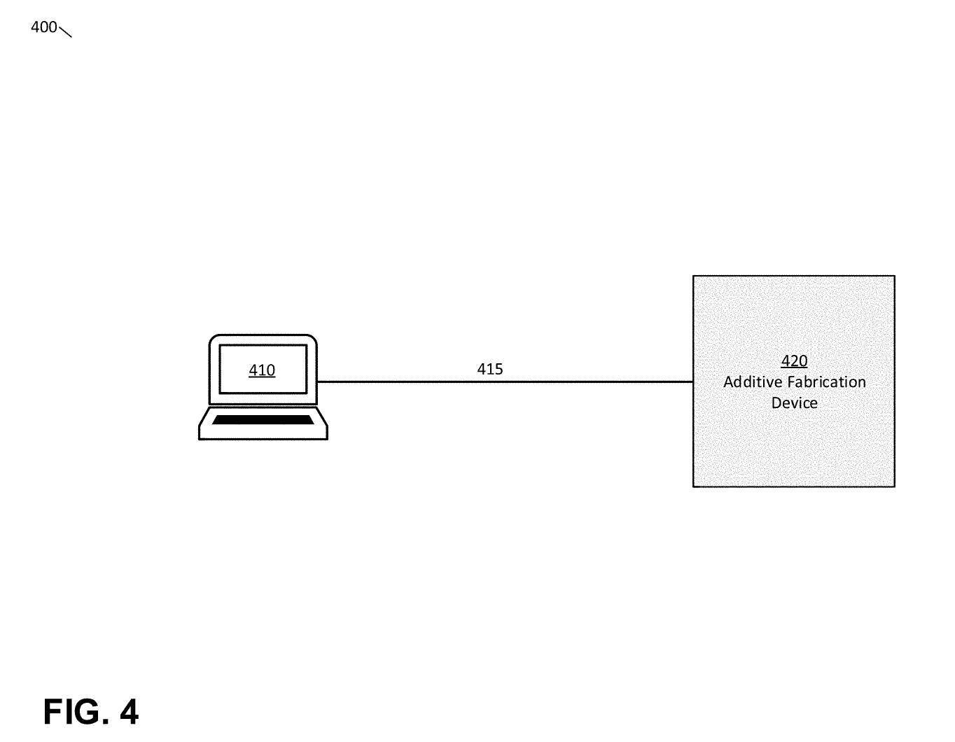

FIG. 4 is a block diagram of a system suitable for practicing aspects of the invention, according to some embodiments. As described above, thermal supports are three-dimensional structures that may be generated to aid in thermal management during fabrication of parts from fine materials, such as powders. System 400 illustrates a system suitable for said generation of thermal supports and subsequent operation of an additive fabrication device to fabricate an object with thermal supports. According to some embodiments, computer system 410 may execute software that generates one or more thermal supports for an object. Such generation may comprise generation of three-dimensional thermal supports based on a three-dimensional model of the object, followed by the determination of a plurality of two-dimensional layers of the combined object-support model (sometimes referred to as “slicing”). Alternatively, a three-dimensional model of the object may be sliced and additional two-dimensional regions representing the thermal support structure may be added to the two-dimensional slices of the object. Irrespective of which approach is employed, the net result is to produce data describing two-dimensional layers that may each comprise sections of the object and/or the thermal support(s). Instructions may then be generated from this layer data to be provided to an additive fabrication device, such as additive fabrication device 420, that, when executed by the device, fabricates the layers and thereby fabricates the object and the thermal support(s). Such instructions may be communicated via link 415, which may comprise any suitable wired and/or wireless communications connection. In some embodiments, a single housing holds the computing device 410 and additive fabrication device 420 such that the link 415 is an internal link connecting two modules within the housing of system 400.

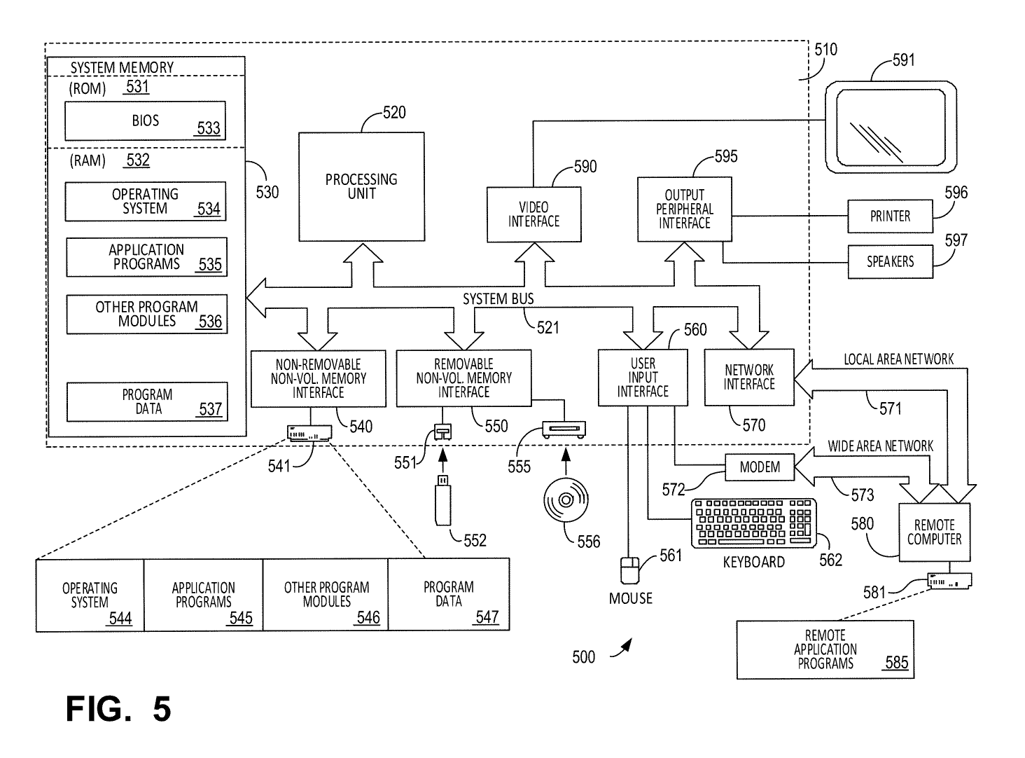

FIG. 5 illustrates an example of a suitable computing system environment 500 on which the technology described herein may be implemented. For example, computing environment 500 may form some or all of the computer system 410 shown in FIG. 4. The computing system environment 500 is only one example of a suitable computing environment and is not intended to suggest any limitation as to the scope of use or functionality of the technology described herein. Neither should the computing environment 500 be interpreted as having any dependency or requirement relating to any one or combination of components illustrated in the exemplary operating environment 500.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 5, an exemplary system for implementing the technology described herein includes a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a flash drive 551 that reads from or writes to a removable, nonvolatile memory 552 such as flash memory, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a non-transitory computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software,” when used herein, are used in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of generating one or more thermal supports for an object, the one or more thermal supports and the object to both be fabricated via an additive fabrication device, the method comprising:
identifying, based on a three-dimensional model of the object, at least a first region of the object to which thermal support is to be provided;
generating at least a first thermal support structure for the first region of the object, the first thermal support structure being positioned under the first region, not in mechanical contact with the first region, and having a tapered shape wherein the first thermal support structure has a cross-sectional area proximate to the first region that is larger than a cross-sectional area of the first thermal support structure distal to the first region; and
generating, using at least one processor, instructions that, when executed by the additive fabrication device, cause the additive fabrication device to fabricate the object and the first thermal support structure.

2. The method of claim 1, wherein the generated instructions, when executed by the additive fabrication device, cause the additive fabrication device to fabricate a plurality of layers of the object above the first thermal support structure and below the first region.

3. The method of claim 1, wherein the first thermal support structure has an inverted rectangular pyramid shape, an inverted triangular pyramid shape, an inverted cone shape, or an inverted hemisphere shape.

4. The method of claim 1, wherein generating the first thermal support structure is based at least in part on a thermal load expected to be produced by fabrication of the first region.

5. The method of claim 1, wherein identifying the first region of the object comprises identifying that the first region of the object comprises at least one overhanging portion.

6. The method of claim 1, further comprising executing the instructions by the additive fabrication device, thereby fabricating the object and the first thermal support structure.

7. The method of claim 1, wherein generating the first thermal support structure is based at least in part on a heat capacity of a material from which the additive fabrication device is configured to fabricated parts.

8. The method of claim 1, wherein the instructions, when executed by the additive fabrication device, cause the additive fabrication device to fabricate the first thermal support structure by providing sufficient energy to a powdered material to consolidate a three-dimensional region according to the first thermal support structure.

9. The method of claim 1, wherein the instructions, when executed by the additive fabrication device, cause the additive fabrication device to fabricate the first thermal support structure by providing energy to a three-dimensional region of powdered material according to the first thermal support structure, wherein said energy heats but does not consolidate the material.

10. At least one computer readable medium comprising processor-executable instructions that, when executed, cause at least one processor to perform a method of generating one or more thermal supports for an object, the one or more thermal supports and the object to be fabricated via an additive fabrication device, the method comprising:
identifying, based on a three-dimensional model of the object, at least a first region of the object to which thermal support is to be provided;
generating, using the at least one processor, at least a first thermal support structure for the first region of the object, the first thermal support structure being positioned under the first region, whilst not in mechanical contact with the first region, and having a tapered shape wherein the first thermal support structure has a cross-sectional area proximate to the first region that is larger than a cross-sectional area of the first thermal support structure distal to the first region; and
generating, using the at least one processor, fabrication instructions that, when executed by the additive fabrication device, cause the additive fabrication device to fabricate the object and the first thermal support structure.

11. The at least one computer readable medium of claim 10, wherein the first thermal support structure has an inverted rectangular pyramid shape, an inverted triangular pyramid shape, an inverted cone shape, or an inverted hemisphere shape.

12. The at least one computer readable medium of claim 10, wherein generating the first thermal support structure is based at least in part on a thermal load expected to be produced by fabrication of the first region.

13. The at least one computer readable medium of claim 10, wherein generating the first thermal support structure is based at least in part on a heat capacity of a material from which the additive fabrication device is configured to fabricated parts.

14. A method of generating one or more supports for an object, the one or more supports and the object to both be fabricated via an additive fabrication device from at least one material, the method comprising:
identifying, based on a three-dimensional model of the object, at least a first region of the object to which support is to be provided;
generating at least a first structure for the first region of the object based at least in part on at least one measure of temperature expected within the at least one material during fabrication of the object, the first structure being positioned under the first region, not in mechanical contact with the first region, and having a tapered shape wherein the first structure has a cross-sectional area proximate to the first region that is larger than a cross-sectional area of the first structure distal to the first region; and
generating, using at least one processor, instructions that, when executed by the additive fabrication device, cause the additive fabrication device to fabricate the object and the first structure.

15. The method of claim 14, wherein the generated instructions, when executed by the additive fabrication device, cause the additive fabrication device to fabricate a plurality of layers of the object above the first structure and below the first region.

16. The method of claim 14, wherein the first structure has an inverted rectangular pyramid shape, an inverted triangular pyramid shape, an inverted cone shape, or an inverted hemisphere shape.

17. The method of claim 14, wherein generating the first structure is based at least in part on a thermal load expected to be produced by fabrication of the first region.

18. The method of claim 14, wherein identifying the first region of the object comprises identifying that the first region of the object comprises at least one overhanging portion.

19. The method of claim 14, wherein generating the first structure is based at least in part on a heat capacity of a material from which the additive fabrication device is configured to fabricated parts.

20. The method of claim 14, wherein the instructions, when executed by the additive fabrication device, cause the additive fabrication device to fabricate the first structure by providing sufficient energy to a powdered material to consolidate a three-dimensional region according to the first structure.

21. The method of claim 14, wherein the instructions, when executed by the additive fabrication device, cause the additive fabrication device to fabricate the first structure by providing energy to a three-dimensional region of powdered material according to the first structure, wherein said energy heats but does not consolidate the material.
